(19) United States
(12) Patent Application Publication
(10) Pub. No.: US 2015/0059903 A1
(43) Pub. Date: Mar. 5, 2015

(54) METHODS AND APPARATUS FOR ARRESTING FAILURES IN SUBMERGED PIPELINES

(71) Applicant: Halliburton Energy Services, Inc., Houston, TX (US)

(72) Inventors: Steven Ray Lovett, Marlow, OK (US); Aimee Kathleen Greening, Duncan, OK (US)

(73) Assignee: Halliburton Energy Services, Inc., Houston, TX (US)

(21) Appl. No.: 14/015,106

(22) Filed: Aug. 30, 2013

(51) Int. Cl. F16L 55/11

(52) U.S. Cl. CPC F16L 55/11
USPC 138/89

(57) ABSTRACT

A packer apparatus is configured to be arranged within and arrest a failure of a submerged pipeline. The packer apparatus is configured to automatically respond to water invasion into the inner diameter of pipe in an offshore pipeline and rapidly deploy a sealing system that will prevent or inhibit the laid pipeline and pipeline above the packer from being flooded with water.

### BACKGROUND

This disclosure relates generally to offshore pipelines, and more specifically to methods and apparatus for responding to failures in offshore submerged pipelines.

In offshore pipeline installations, as the pipeline is laid on the sea floor the pipeline is subjected to significant forces and moments that can compromise the integrity of the pipeline and, in some cases, cause failures. In the event the submerged pipeline is compromised to the point of failure, water rushes into the pipeline. Such failures are commonly referred to as wet buckles. Once a wet buckle occurs the flooded pipeline is too heavy to retrieve for repair and re-installation.

Companies that lay the pipeline keep a fleet of compressor ships on standby while the pipeline is being laid on the sea floor in case of a failure like a wet buckle. The compressor ships are present to pump the water out of the pipeline to facilitate repair of the buckled section, by allowing the pipeline to be pulled back to the surface, to the pipelay vessel, for removal of the damaged section. After the water has been removed, sections of the damaged pipeline can be retrieved and brought to the surface and the pipelay vessel can continue laying pipe onto the sea floor.

Pipeline failures like wet buckles are relatively rare. As such, during installation, the fleet of compressor ships hired by the pipeline installation company is generally inactive and serves no function for the installation process unless the rare failure occurs. The cost of the compressor ships and the associated service the ships and crew provide can reach the millions of dollars.

### BRIEF DESCRIPTION OF DRAWINGS

FIG. 1 schematically depicts a submerged pipeline installation system including wet buckle packers in accordance with this disclosure.

FIG. 2 depicts an elevation view of an example wet buckle packer in accordance with this disclosure.

FIG. 3A depicts a section view of the example packer of FIG. 2 in an unengaged state within a pipeline.

FIG. 3B depicts a section view of the example packer of FIG. 2 in an engaged state within a pipeline.

FIG. 4 depicts an elevation view of another example wet buckle packer in accordance with this disclosure.

FIG. 5 depicts an example method of arresting a failure in a submerged pipeline.

### DETAILED DESCRIPTION

In view of the foregoing costs and other inefficiencies associated with recovering from an offshore pipeline failure, examples according to this disclosure are directed to methods and apparatus for automatically responding to water invasion into the inner diameter of pipe in an offshore pipeline and rapidly deploying a sealing system that will prevent or inhibit the laid pipeline from being flooded with water.

A packer apparatus in accordance with this disclosure is configured to be arranged within and arrest a failure of a submerged pipeline. In one example, the packer apparatus includes first, second and third mandrels, a brake, and first and second elastomeric expansion boots. The first and second mandrels are in axial moveable relation with the third mandrel, which is arranged between the first and second mandrels. The brake is arranged between the first and second mandrels. The first elastomeric expansion boot is arranged between a radially extending flange of the first mandrel and a first radially extending flange of the third mandrel. The second elastomeric expansion boot is arranged between a radially extending flange of the second mandrel and a second radially extending flange of the third mandrel. The first mandrel is configured to move axially toward the third mandrel from a first position to a second position. The second mandrel is configured to move axially toward the third mandrel from a first position to a second position.

In the second position of the first mandrel, the radially extending flange of the first mandrel is closer to the first radial extending flange of the third mandrel than in the first position, and the first expansion boot is compressed axially between the radially extending flange of the first mandrel and the first radially extending flange of the third mandrel and is expanded radially into engagement with an inner surface of the pipeline. In the second position of the second mandrel, the radially extending flange of the second mandrel is closer to the second radial extending flange of the third mandrel than in the first position, and the second expansion boot is compressed axially between the radially extending flange of the second mandrel and the second radially extending flange of the third mandrel and is expanded radially into engagement with an inner surface of the pipeline. Additionally, in the second position of the first and second mandrels, the brake moves radially outward into engagement with the inner surface of the pipeline.

In the following examples, the apparatus for arresting pipeline wet buckles (and other pipeline failures) is referred to as a wet buckle packer. However, the apparatus could also be referred to as a plug, a shutoff pig, a baffle, or other terms connoting a device that restricts, and ideally prevents fluid flow through an annular pipeline.

Wet buckle packers in accordance with this disclosure provide a number of functions once actuated. Packer apparatus in accordance with this disclosure are sometimes referred to as configured to arrest a failure like a wet buckle in a submerged pipeline. Arresting a failure in a pipeline includes a number of different functions. In both dry and wet buckles, for example, the pipeline failure can include a structural failure including a buckle that causes the pipeline to at least partially collapse on itself. The structural buckle can run along the length of the pipeline unless it is arrested. In wet buckles, water also invades the inner diameter of the pipe causing the pipeline to become flooded. Packer apparatus in accordance with this disclosure can function to arrest both a structural buckle in a submerged pipeline, whether from a dry or wet buckle, and deploy a sealing system that will prevent or inhibit the laid pipeline from being flooded with water in the event of a wet buckle. The packer seals the inner diameter of the pipeline to prevent or significantly inhibit water from flooding the submerged pipeline. Additionally, the packer deploys a braking mechanism to prevent or inhibit the packer from moving within the pipeline under the significant pressures introduced by the sea (or fresh) water entering the pipe from the wet buckle.

As noted above, wet buckle packers in accordance with this disclosure are configured to be automatically actuated to seal the pipeline from ingress of water. The mechanisms for sealing and braking employed in a wet buckle packer can be actuated in a variety of ways. For example, electrical, hydraulic, or pneumatic supply lines can be run from the pipelay vessel on the surface to the packer. The wet buckle packer could also include a power source, e.g., a battery that could be used to actuate the seal and brake mechanisms. The packers or the systems in which they are employed can be configured to be actuated automatically using a variety of different sensors configured to detect water invasion into the pipeline.

Wet buckle packers in accordance with this disclosure provide a new approach to seal and anchor a packer-type plug in place within a pipeline in the event of a wet buckle. The packers are designed to provide increased durability and to include component parts that protect against external variances. Example wet buckle packers can provide a number of advantages including, e.g., removing the high cost of air compressor standby in submerged pipeline installations and providing a simple and cost effective device for arresting failures in the pipeline.

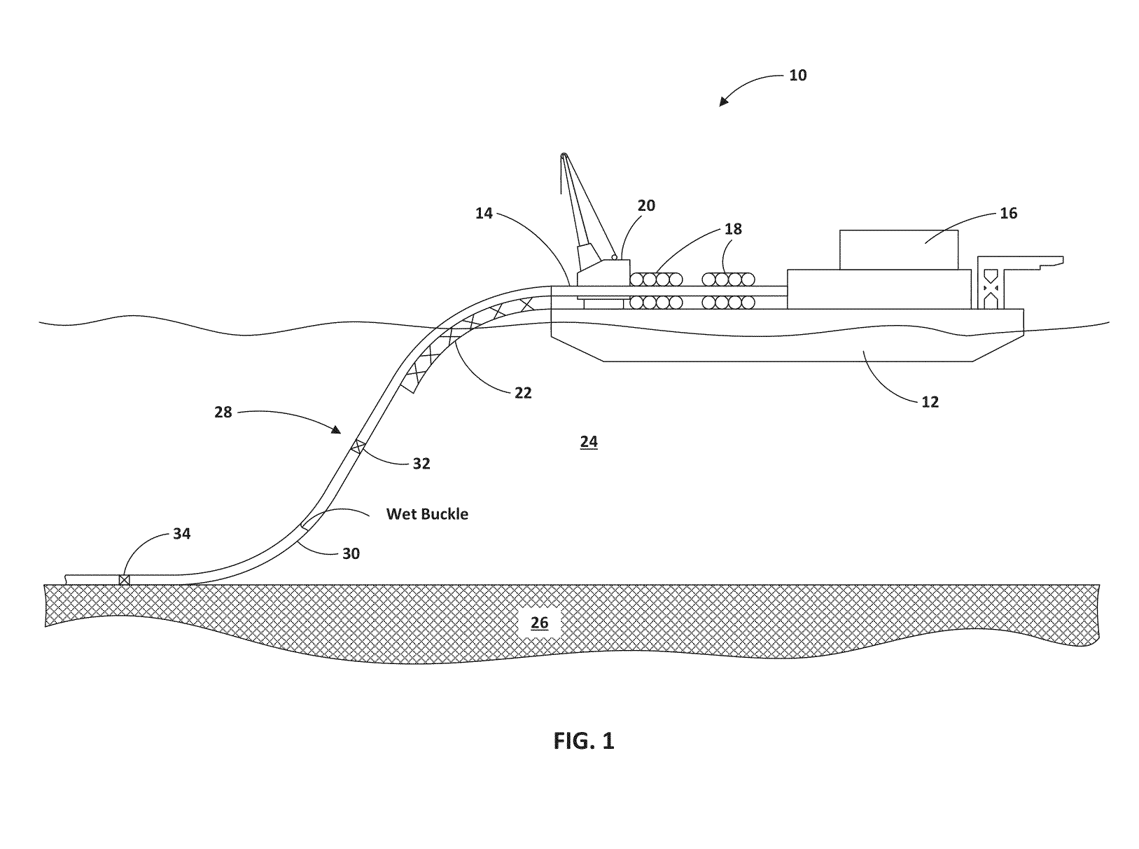

FIG. 1 depicts a submerged pipeline installation system 10. Offshore submerged pipelines can be installed in a number of ways. In general, individual pipes are transported by a cargo ship to a pipelay vessel at the pipeline installation location. The individual pipes are processed and connected to one another on the pipelay vessel and laid onto the sea floor. The pipelay vessel progressively welds individual pipes or welded pipe sections to one another to assemble the pipeline. As the pipeline is assembled the pipelay vessel moves across the surface of the water and the assembled pipeline is pulled off of the ship by the weight of the pipeline. As the pipeline is progressively pulled off of the back of the pipelay vessel it descends to the sea floor.

Two methods that are employed to install submerged pipelines are the “J” lay and the “S” lay. The moniker of each method represents the shape of the pipeline as it is pulled off of the pipelay vessel onto the sea floor. In a “J” lay, the pipeline is pulled off of the pipelay vessel substantially vertically to near the sea floor, where the pipeline bends to run horizontally along the floor. In an “S” lay, the pipeline is pulled off of the pipelay vessel substantially horizontally, bends vertically down toward the sea floor and then bends back horizontally away from the vessel to run along the sea floor. Although the following examples are described in the context of an “S” lay installation, wet buckle packers in accordance with this disclosure can also be employed in a “J” lay installation system or other pipeline installation methods not covered here.

FIG. 1 depicts a submerged pipeline installation system 10 for an “S” lay installation. In FIG. 1, system 10 includes pipelay vessel 12 and pipeline 14. Pipelay vessel 12 includes production factory 16, tensioners 18, crane 20, and stinger 22. As described in more detail below, after individual pipes are transported to and loaded on pipelay vessel 12, the pipes are conveyed into production factory 16. Production factory 16 includes a variety of processing stations for preparing pipes and coupling individual pipes into pipe sections and ultimately assembling pipeline 14, as will be known to persons skilled in the art.

Pipelay vessel 12 is shown floating in a body of water 24. Pipelay vessel 12 utilizes crane 20 to perform heavy lifting operations, including loading pipes from a cargo ship onto the vessel. In general, individual pipes on board pipelay vessel 12 are placed on an assembly line within production factory 16 and joints of the pipes are welded into pipeline 14. Pipeline 14 is held in tension between sea floor 26 and pipelay vessel 12 by pipeline tensioners 18 as the pipeline is lowered. As pipelay vessel 12 moves forward by pulling on a mooring system off of the bow, pipeline 14 is lowered from pipelay vessel 12 over stinger 22. Stinger 22 is attached to and extends from the stern of pipelay vessel 12, and provides support for pipeline 14 as it leaves pipelay vessel 12.

In practice, a cargo ship transports pipe sections (sometimes referred to as stands) to pipelay vessel 12. Crane 20 moves pipe sections from the cargo ship to pipelay vessel 12 onto cradles that form a conveyor system for moving pipe into production factory 16. Within production factory 16, a number of different operations are carried out to prepare and join pipe sections. For example, the pipe ends are beveled (and bevels are deburred). The pipe ends are preheated within production factory 16 and moved through a number of welding stations to join different sections with weld beads applied both to the outer and inner diameters of the sections at the joints. In some cases, a final welding station within production factory 16 applies a welded cap to the joints of pipe sections.

The joints of the welded pipe sections can also be tested within production factory 16. For example, the welded joints can pass through ultrasonic testing stations that apply water to the joints as the medium to transmit the ultrasonic signals. The ultrasonic signals can be processed by a computing system and graphically displayed for inspection by an operator.

After testing, the joints of the welded pipe sections can be grit blasted and a field joint coating can be applied. In some installation systems, each individual pipe is subjected to this process as it is welded to pipeline 14. In other cases, multiple pipes, e.g. two pipes in a double stand facility, are first welded together and then welded to the pipeline in the firing line onboard pipelay vessel 12. At any rate, the assembled pipeline 14 is ultimately conveyed through tensioners 18 and over stinger to be dropped off of the stern of pipelay vessel 12 to sea floor 26.

As pipeline 14 is laid on sea floor 26, suspended pipe span 28 forms a shallow “S” shape between sea floor 26 and pipelay vessel 12. The “S” shape of suspended pipe 28 is sometimes referred to as the S-curve. Second curve 30 or the tail of the S-curve just before suspended pipe span 28 meets sea floor 26 is sometimes referred as the “sagbend.” The S-curve of pipeline 14 is controlled by stinger 22 and pipeline tensioners 18. Increases in the curvature of pipeline 14 cause increases in the bending moment on the pipeline, and, as a result, higher stresses. High stresses on pipeline 14 and, in particular, on suspended pipe span 28 can result in buckling of the pipeline 14. For example, a loss of tension in pipeline 14 during the pipe lay will normally cause pipeline 14 to buckle at a point along the suspended pipe span 28. A buckle in pipeline 14 is called a wet buckle if pipeline 14 has cracked or becomes damaged in such a manner that water is allowed to enter the inner diameter of the pipeline. The influx of water into the pipeline 14 greatly increases the weight of suspended pipe span 28 such that the pipe can become over stressed at a location along suspended pipe span 28, generally near stinger 22. In such circumstances, flooded pipeline 14 can break and drop from pipelay vessel 12 to sea floor 26. Regardless of whether pipeline 14 breaks in the event of a wet buckle, the increased weight can prevent recovery of and repair to pipeline 14 before the water is pumped out of the pipeline.

Examples according to this disclosure are directed to a wet buckle packer that can be deployed within the inner diameter of pipeline 14 as it is laid on sea floor 26. In FIG. 1, installation system 10 includes two wet buckle packers 32 and 34 deployed within pipeline 14. Packer 32 is deployed along suspended pipe span 28, while packer 34 is deployed downpipe where pipeline 14 meets sea floor 26. Wet buckle packers 32 and 34 are deployed within pipeline 14 with a hoist line or cable (not shown). In cases where multiple wet buckle packers are deployed in series, a hoist line may be coupled between the packers. In the example of FIG. 1, a hoist line may be coupled to a hoist on pipelay vessel 12 to packer 32 and another line can be coupled between packers 32 and 34. As will be apparent to persons skilled in the art, substantial benefits can be realized through an alternative configuration using only a single wet buckle packer, located generally in the position of depicted packer 34, positioned to prevent substantial inflow of water into the already-laid portion of pipeline 14 on sea floor 26.

Wet buckle packers 32 and 34 are configured to automatically respond to water invasion into the inner diameter of pipeline 14 and rapidly deploy a sealing system that will prevent the laid pipeline and pipeline above packer 32 from being flooded with sea water. For example, wet buckle packers 32 and 34 seal the inner diameter of pipeline 14 to prevent or significantly inhibit water from flooding the submerged pipeline. Additionally, wet buckle packers 32 and 34 deploy a braking mechanism to prevent or inhibit the packers from moving within pipeline 14 as a result of the pressures introduced by the sea water entering the pipe from the wet buckle.

In some cases one or more “piggy-back” lines may be laid from pipelay vessel 12 along with main pipeline 14. Piggy-back lines are generally constructed from smaller diameter pipes that are assembled in a similar manner as described above with reference to pipeline 14. The piggy-back lines are assembled in parallel with and are then coupled to pipeline 14, e.g., with a sleeve connected to top of the main pipeline 14 in which the piggy-back lines are received.

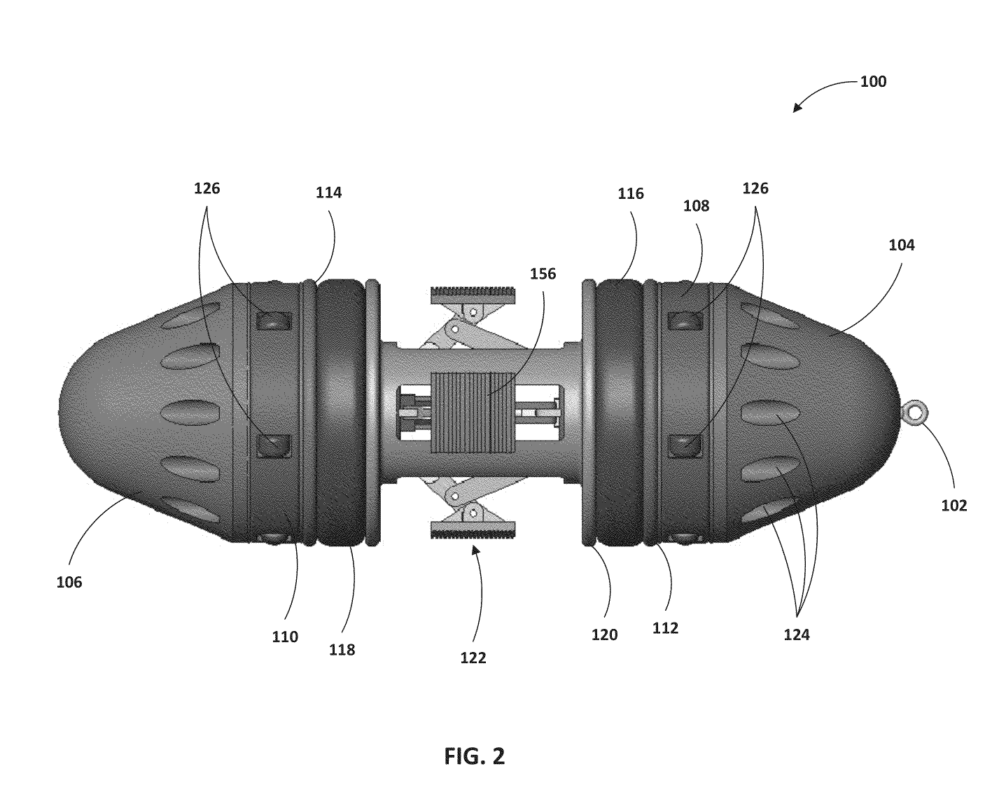

FIG. 2 depicts example wet buckle packer 100. Packer 100 includes a hoist ring 102, end caps 104 and 106, bearings 108 and 110, first and second mandrels 112 and 114, expansion boots 116 and 118, a third mandrel 120, and a brake assembly 122. Packer 100 is configured such that similarly configured components are arranged axially on both ends of a central assembly including third mandrel 120 and brake assembly 112, disposed generally in the middle of packer 100. End caps 104 and 106 generally define either end of packer 100. Caps 104 and 106, bearings 108 and 110, and first and second mandrels 112 and 114 are connected to one another via fasteners (not shown), such as bolts, received within apertures 124. Expansion boot 116 is disposed between first mandrel 112 and third mandrel 120. Similarly, expansion boot 118 is disposed between second mandrel 114 and third mandrel 120. Packer is coupled to hoist line 113 by hoist ring 102, which is connected to cap 104.

Packer 100 is configured to be connected to hoist line 113 and deployed from a pipelay vessel down a submerged pipeline. Packer 100 can be lowered into an already submerged pipeline or can be lowered along with a particular section of the pipeline as it is lowered to the sea floor. Bearings 108 and 110 each include a number of freely rotating wheels 126 distributed around the outer circumference of the bearings. Wheels 126 facilitate travel of packer 100 through the submerged pipeline as packer 100 is lowered from the pipelay vessel and as otherwise may be needed during the pipe laying process.

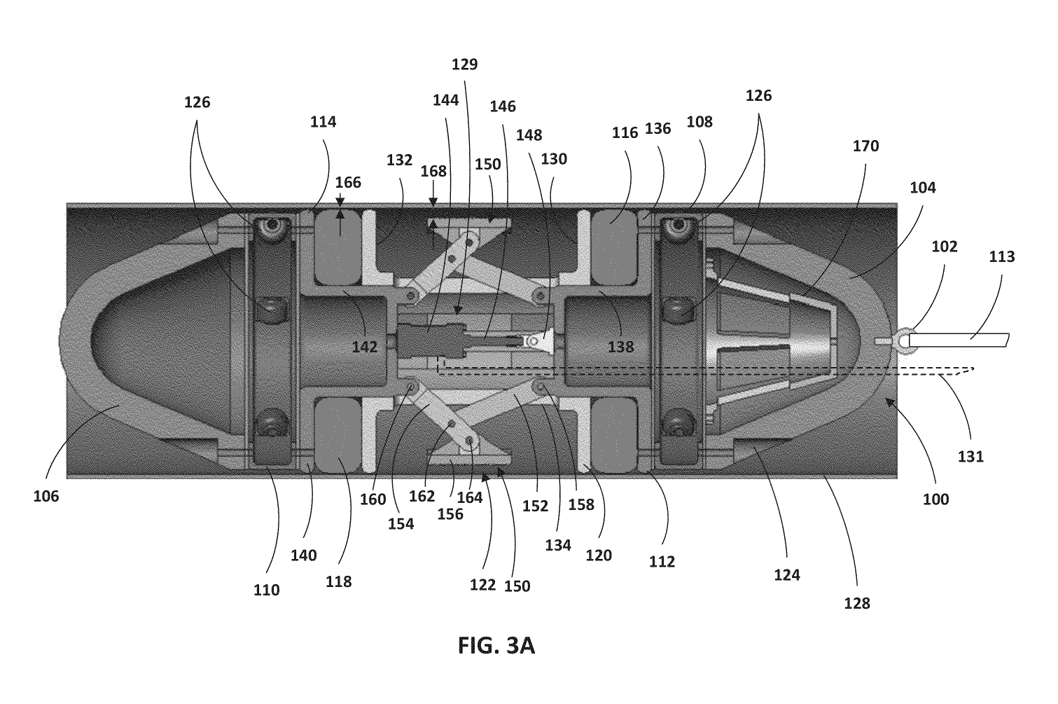

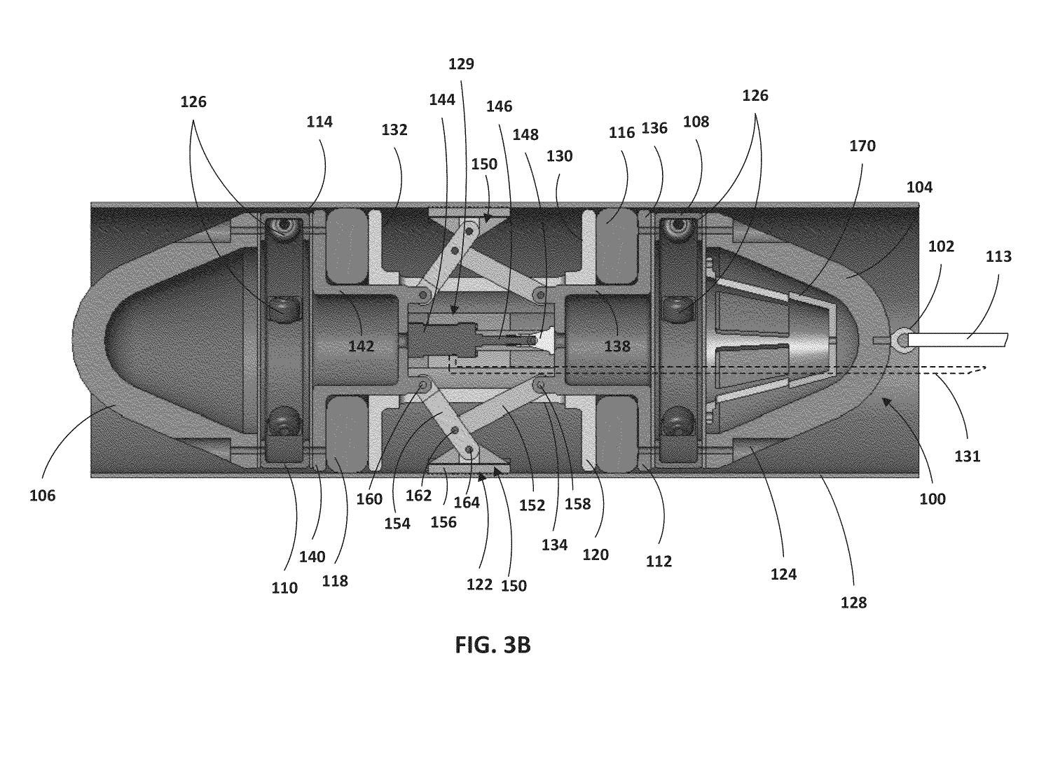

Packer 100 can be deployed at a number of locations within the submerged pipeline to arrest pipeline failures like wet buckles. For example, packer 100 can be deployed along a suspended pipe span of the pipeline or further downpipe where the pipeline meets the sea floor. Wet buckle packer 100 is configured to automatically respond to water invasion into the inner diameter of the pipeline and rapidly deploy a sealing system that will prevent the laid pipeline and pipeline above packer 32 from being flooded with sea water, which is described in more detail with reference to FIGS. 3A and 3B.

FIGS. 3A and 3B depict section views of wet buckle packer 100 within pipeline 128. In FIG. 3A, packer 100 is unengaged with pipeline 128. In FIG. 3B, packer 100 is engaged with pipeline 128 to substantially seal the inner diameter of pipeline 128 from water invasion. As illustrated in the section views of FIGS. 3A and 3B, packer 100 includes actuator 129 in addition to hoist ring 102, end caps 104 and 106, bearings 108 and 110, first and second mandrels 112 and 114, expansion boots 116 and 118, third mandrel 120, and brake assembly 122. Actuator 129 and brake assembly 122 are connected to both first and second mandrels 112 and 114. Supply line 131 is coupled to actuator 129. Supply line 131 is schematically illustrated in FIGS. 3A and 3B in a dashed line format.

Caps 104 and 106, bearings 108 and 110, and first and second mandrels 112 and 114 can be connected to one another in a variety of ways. In the example of FIGS. 3A and 3B, caps 104 and 106, bearings 108 and 110, and first and second mandrels 112 and 114 are connected to one another via fasteners (not shown) received within apertures 124. In another example, however, caps 104 and 106, bearings 108 and 110, and first and second mandrels 112 and 114 could be welded to one another.

First and second mandrels 112 and 114 are configured to move axially relative to third mandrel 120. Third mandrel 120 includes an “I” shaped cross-section with two end plates 130 and 132 connected by a central shaft 134. First and second mandrels 112 and 114 each include a “T” shaped cross-sectional shape. First mandrel 112 includes end plate 136 and central shaft 138. Second mandrel 114 includes end plate 140 and central shaft 142. Shaft 138 of first mandrel 112 is received within a bore in shaft 134 at one end of third mandrel 120. Shaft 142 of second mandrel 114 is received within the bore of shaft 134 at the other end of third mandrel 120. Each of first and second mandrels 112 and 114 are configured to move axially relative to third mandrel 120 from the ends toward the middle of packer 100.

Actuator 129 is connected to both first and second mandrels 112 and 114 and is disposed within the bore of central shaft 134 of third mandrel 120. Actuator 129 is depicted schematically in FIGS. 3A and 3B, but generally includes housing 144 and shaft 146 movably connected to housing 144. Shaft 146 is configured to slide in and out of housing 144. Housing 144 is connected to second mandrel 114. Shaft 146 is pivotally connected to first mandrel 112 via clevis 148 connected to the end of shaft 146.

Actuator 129 can be a variety of mechanical and electromechanical devices that are configured to be actuated to cause shaft 146 to move axially relative to housing 144. For example, actuator 129 can include a pneumatically or hydraulically actuated piston that drives shaft 146 with air or a hydraulic fluid supplied by supply line 131. In another example, actuator 129 includes an electrically activated solenoid that drives shaft 146. In another example, actuator 129 includes an electromagnetic piston that drives shaft 146 based on controlled electricity transmitted to packer 100 via supply line 131. In another example, actuator 129 includes an electric motor and screwjack, which can drive shaft 146 using electricity transmitted to packer 100 via supply line 131. In some cases, actuator 129 can be powered by a power source like a battery deployed with packer 100.

Actuator 129 is configured to cause the distal end of shaft 146 (i.e., the end coupled to first mandrel 112 via clevis 148) to move axially relative to housing 144. As the distal end of shaft 146 changes axial position with respect to housing 130, first and second mandrels 112 and 114 move relative to one another and to third mandrel 120 arranged between the two first and second mandrels.

Expansion boots 116 and 118 are annular elastomeric boots that surround shaft 138 of first mandrel 112 and shaft 142 of second mandrel 114, respectively. Expansion boot 116 is arranged between end plate 136 of first mandrel 112 and end plate 130 of third mandrel 120. Similarly, expansion boot 118 is arranged between end plate 140 of second mandrel 114 and end plate 132 of third mandrel 120.

As first mandrel 112 moves axially toward third mandrel 120, expansion boot 116 is compressed axially as plates 136 and 130 move closer to one another. As expansion boot 116 is compressed axially, boot 116 also radially expands into engagement with an inner surface of pipeline 128. Similarly, as second mandrel 114 moves axially toward third mandrel 120, expansion boot 118 is compressed axially as plates 140 and 132 move closer to one another. As expansion boot 118 is compressed axially, boot 118 also radially expands into engagement with the inner surface of pipeline 128.

Brake assembly 122 includes a number of brake arms 150, which are distributed at different angularly disposed, circumferential positions around a longitudinal axis of packer 100. In the example of FIGS. 3A and 3B, brake assembly 122 includes four brake arms 150 offset from one another at approximately 90 degrees about the longitudinal axis of packer 100. However, in other examples, packer 100 or other wet buckle packers in accordance with this disclosure could include more or fewer brake arms. For example, packer 100 could include a brake with three brake arms offset from one another at approximately 120 degrees about the longitudinal axis of packer 100. In another example, packer 100 could include a brake with five brake arms offset from one another at approximately 72 degrees about the longitudinal axis of packer 100. Additionally, the brake arms of the wet buckle packer could be unevenly distributed about the longitudinal axis of packer 100 such that the angular offset between different sets of brake arms is different.

Brake arms 150 each include two links 152, 154 and pad 156 at the radially outward end of link 154. For each brake arm 150, link 152 is pivotally coupled to first mandrel 112 at pivot 158. Link 154 is pivotally coupled to second mandrel 114 at pivot 160. Links 152 and 154 project toward each other and are pivotally coupled to one another at pivot 162 between first and second mandrels 112 and 114. Brake pad 156 is pivotally coupled to link 154 at pivot 164 near the end of link 154 opposite the end connected to second mandrel 114.

As first and second mandrels 112 and 114 moves axially toward third mandrel 120, pivots 158 and 160 are drawn closer together generally axially. Link 152 rotates about pivot 158 and link 154 rotates about pivot 160 and links 152 and 154 pivot relative to one another about pivot 162. The end of links 152 and 154 adjacent pivot 162 and brake pad 156 are moved radially outward, which pushes brake pad 156 radially outward into engagement with the inner surface of pipeline 128. As brake pad 156 engages pipeline 128, pad 156 rotates about pivot 164 to generally align the radially outer face of pad 156 with the inner surface of pipeline 128. Additionally, the outer surface of brake pad 156 includes a saw-tooth profile defined by a series of circumferentially extending ridges, which are configured to engage the inner surface of pipeline 128 without slipping. In many examples, the ridges will not be symmetrical, but will be configured particularly to prevent movement in the direction toward end cap 106 (i.e., away from the likely location of water influx due to a wet buckle). In one example, pad 156 is manufactured from steel and, in some cases, can include carbide buttons that form the saw-tooth profile of pad 156.

Packer 100 can be actuated from the pipelay vessel on the surface of the sea in the event of a wet buckle in a submerged portion of pipeline 128, e.g., in the sag bend of the “S” curve formed by the suspended span of pipeline 128 as it descends to the sea floor. Packer 100 can include a sensor system that detects the invasion of water into the inner diameter of pipeline 128. In another example, the sensor system can be associated with a separate component and be communicatively coupled to packer 100. In one example, the sensor system includes a water sensor including two spaced electrodes arranged within pipeline 128 such that water invading the pipeline would complete an electrical circuit of the sensor. In another example, a pressure sensor could be used to detect the invasion of water into the inner diameter of pipeline 128.

The sensor system communicatively coupled to packer 100 can provide a signal directly to control electronics included in actuator 129 or can transmit signals to a surface system, which, in turn, transmits control signals to actuator 129 via supply line 131. In the event water invasion is detected, actuator 129 causes the distal end of shaft 146 to move axially closer to housing 144. As the distal end of shaft 146 changes axial position with respect to housing 144, first and second mandrels 112 and 114 are drawn axially toward third mandrel 120, which functions to axially compress and radially expand expansion boots 116 and 118. In the radially expanded state illustrated in FIG. 3B, expansion boots 116 and 118 are configured to substantially seal the inner diameter of pipeline 128 and thereby arrest or mitigate the wet buckle in pipeline 128.

Actuator 129 also deploys brake assembly 122 to prevent or substantially inhibit movement of packer 100 within pipeline 128. For example, actuator 129 causes the distal end of shaft 146 to move axially closer to housing 144. As the distal end of shaft 146 changes axial position with respect to housing 144, first and second mandrels 112 and 114 are drawn axially toward third mandrel 120. Movement of first and second mandrels 112 and 114 relative to third mandrel 120 causes links 152 and 154 to rotate and push brake pad 156 radially outward into engagement with the inner surface of pipeline 128 to prevent or inhibit packer 100 from moving within the pipeline.

Although it is not illustrated in FIGS. 3A and 3B, packer 100 can include a locking mechanism that is configured to lock brake assembly 122 once it has been engaged. In one example, the locking mechanism includes a ratchet mechanism that is configured to allow first and second mandrels 112 and 114 to move toward third mandrel 120, while preventing first and second mandrels 112 and 114 from moving away from third mandrel 120 after brake assembly 122 has been engaged. An example ratchet mechanism that could be configured for use with packer 100 is disclosed and described in described in U.S. application Ser. No. ______ (Atty. Docket No. 1880.517US1), filed Jul. ______, 2013 and entitled “METHODS AND APPARATUS FOR ARRESTING FAILURES IN SUBMERGED PIPELINES,” the entire contents of which are incorporated herein by reference.

Packer 100 is configured such that in the unengaged state illustrated in FIG. 3A the outer boundaries of packer 100 are offset from the inner surface of pipeline 128. The offset distance between packer 100 and the inner surface of pipeline 128 may differ at different points along the axial length of packer 100. For example, offset 166 between expansion boots 116 and 118 and the inner surface of the pipeline 128 is different than offset 168 between brake pads 156 and the inner surface of pipeline 128. In one example, packer 100 is designed such that offset 166 is less than or equal to approximately ⅛ inch and offset 168 is greater than ⅛ inch. However, in other examples, offsets 166 and 168 can be larger or smaller depending on the clearance between packer 100 and pipeline 128 necessary to allow packer 100 to be deployed through pipeline 128 and the amount of radial expansion of expansion boots 116 and 118 and brake pads 156 that is provided when actuator 129 moves first and second mandrels 112 and 114 relative to third mandrel 120.

Although particular offset distances are described with reference to example packer 100, a packer in accordance with this disclosure will be constructed with a desired dimensional relationship with the dimensions of the pipeline in which the device is to be used. In one example configuration, a radial clearance of approximately ⅛ inch will separate the sealing element of the packer and the pipeline inner surface and a radial clearance of approximately ¼ inch will separate the braking element of the packer and the pipeline inner surface. However, as will be apparent to persons skilled in the art, difference radial dimensions may be used for any size pipe, and in some cases such dimensions may be determined by other factors, such as the designed radius of bends the pipeline will experience while being installed on the sea floor, and/or the intended characteristic of the internal welds used to join the pipeline sections.

In some cases, it may be desirable to configure packer 100 such that offset 166 between expansion boots 116 and 118 and the inner surface of the pipeline 128 is as small as possible while still allowing packer 100 to be deployed downpipe within pipeline 128. In the example of FIG. 3A, the outer peripheries of end caps 104 and 106, bearings 108 and 110, and expansion boots 116 and 118 are configured to fit closely with the inner surface of pipeline 128 even when packer 100 is in an unengaged state. In practice, there may be a delay between the occurrence of a wet buckle to pipeline 128 and the resulting detection of the invasion of water caused by the wet buckle (depending in part on the location of a water sensor, if used), and activation of actuator 129 to cause expansion boots 116 and 118 and brake assembly 122 to engage the inner surface of pipeline 128. During the delay in actuation of packer 100 some water may pass through packer 100. Reducing offset 166 between expansion boots 116 and 118 and the inner surface of the pipeline 128 will reduce the amount of water that floods pipeline 128 before packer 100 is engaged and the boots substantially seal the pipeline.

As is illustrated in FIG. 3A, end caps 104 and 106, bearings 108 and 110, first and second mandrels 112 and 114, and third mandrel 120 are hollow components. It may be desirable to design the components of packer 100 and other wet buckle packers in accordance with this disclosure as such in order to reduce the weight of the device. Packer 100 may be employed in relatively large pipelines. In one example, pipeline 128 has an inner diameter that is approximately equal to 40 inches. The large size of pipeline 128 necessitates a relatively large packer to seal the inner diameter of the pipeline. As such, in one example, packer 100 may weigh on the order of the thousands of pounds. In such situations, removing as much material from end caps 104 and 106, bearings 108 and 110, first and second mandrels 112 and 114, third mandrel 120, and other components of packer 100 can have a significant impact on the weight of the device.

The overall weight of packer 100 also affects the amount of load on hoist line 113 and, as such, the amount of work required by the hoist machine operating hoist line 113. As such, reducing the weight of packer 100 can also reduce the cost and complexity of deploying packer 100 via hoist line 113.

The forces encountered by packer 100 in the event of a wet buckle of pipeline 128 may be significant. For example, at a relatively shallow depth of approximately 1500 feet below sea level, the pressures generated by a wet buckle can reach approximately 660 pounds per square inch (psi). At a depth of approximately 12,000 feet, the pressures generated by a wet buckle can reach approximately 5280 psi. In view of the range of forces potentially encountered by wet buckle packer 100, the wall thicknesses of the components of packer 100 may need to be adjusted to withstand large forces/pressures.

It is also noted that the forces encountered by different portions of packer 100 may differ significantly. For example, portions of packer 100 may be partially or substantially pressure balanced because water introduced into pipeline 128 is allowed to enter parts of packer 100. In such situations, the pressure of the water is balanced on particular portions of packer 100. For example, water may be allowed to enter portions of packer 100 such that the pressure is balanced on either side of a wall of one or more of end caps 104 and 106, bearings 108 and 110, second mandrel 114, and third mandrel 120. In one example, most or all of the components of packer 100 except first mandrel 112 will be substantially pressure balanced if seals are provided between clevis 148 and second mandrel 114 and between bearing 108 and second mandrel 114. In some examples, therefore, packer 100 may be designed to allow pressure balancing of some portions of the device such that the wall thicknesses of different portions of end caps 104 and 106, bearings 108 and 110, first and second mandrels 112 and 114, third mandrel 120, and other components of packer 100 may differ significantly depending on the amount of pressure/force encountered in the event of a wet buckle.

In order to engage packer 100 including radially expanding expansion boots 116 and 118 and setting brake assembly 122, actuator 129 is configured to generate a range of setting forces. In one example, actuator 129 is configured to generate a setting force approximately equal to 60,000 pounds to substantially seal pipeline 128 with expansion boots 116 and 118 and prevent or inhibit movement of packer 100 with brake assembly 122. In other examples, actuator 129 is configured to generate a setting force that is less or greater than 60,000 pounds. For example, in a smaller diameter pipe approximately equal to 7 inches, actuator 129 is configured to generate a setting force approximately equal to 12,000 pounds.

A variety of materials can be used to fabricate the components of packer 100 including, e.g., metals, plastics, elastomers, and composites. For example, bearings 108 and 110, first and second mandrels 112 and 114, and third mandrel 120 can be fabricated from a variety of different types of steel or aluminum. Expansion boots 116 and 118 can be fabricated from a variety of elastomeric materials including rubber. Additionally, end caps 104 and 106 and/or brake pads 156 can be fabricated from a variety of elastomers. In the example of FIGS. 3A and 3B, end caps 104 and 16 are illustrated as fabricated from an elastomer. In such cases, end cap 104 may need to be structurally reinforced to withstand the pressures caused by the invasion of water into pipeline 128. As such, packer 100 includes scaffold cone 170, which is configured to limit the amount end cap 104 can collapse inward in the event of a wet buckle. Scaffold cone 170 can be fabricated from a strong, rigid material such as steel or aluminum.

In one example, end caps 104 and 106, expansion boots 116 and 118, and/or brake pads 156 are fabricated from a nitrile rubber. At the sea floor, packer 100 may encounter temperatures as low as 32 degrees Fahrenheit (0 degrees Celsius). As such, end caps 104 and 106, expansion boots 116 and 118, and/or brake pads 156 may need to be fabricated from elastomers that can withstand relatively low temperatures without significantly affecting the material properties of the components. For example, expansion boots 116 and 118 may need to be fabricated from elastomers that can withstand relatively low temperatures without causing the expansion boots to become too hard, stiff and/or brittle such that the boots are incapable of sufficiently sealing the inner diameter of pipeline 128. The components of packer 100 can be fabricated using a variety of techniques including, e.g., machining, injection molding, casting, and other appropriate techniques for manufacturing such parts.

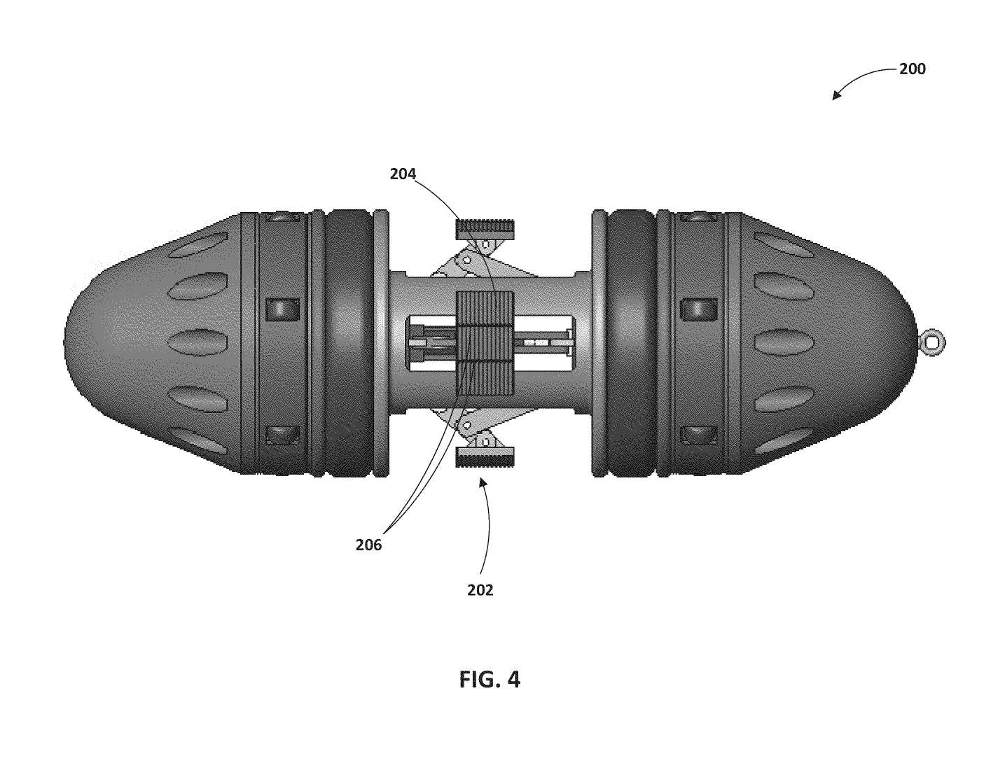

FIG. 4 depicts another example wet buckle packer 200 in accordance with this disclosure. Packer 200 is substantially similar to packer 100 in function and structure, except with respect to the configuration of the pads of brake 202 of packer 200. Referring again to FIG. 2, packer 100 includes brake assembly 122 including brake pads 156. Each brake pad 156 associated with each brake arm of brake assembly 122 is larger in the axial direction than in the circumferential direction. In FIG. 4, however, packer 200 includes brake 202 including brake pad 204, which is larger in the circumferential direction than in the axial direction. Additionally, brake pad 204 includes axial grooves 206. Grooves 206 can have a “V” shaped cross-sectional profile and can function to clear debris accumulated on brake pad 204, which, in turn, can improve braking performance.

In the examples of packer 100 and packer 200, both pads 156 and pads 204 are single, unitary components. In other examples, however, the packers can include brakes including a number of brake arms, each of which includes a plurality of separate brake pads. For example, each brake arm of the brake can include two, three, or more brake pads. In such cases, providing a small offset between the separate brake pads could also function to clear debris accumulated on the pads to potentially improve braking performance.

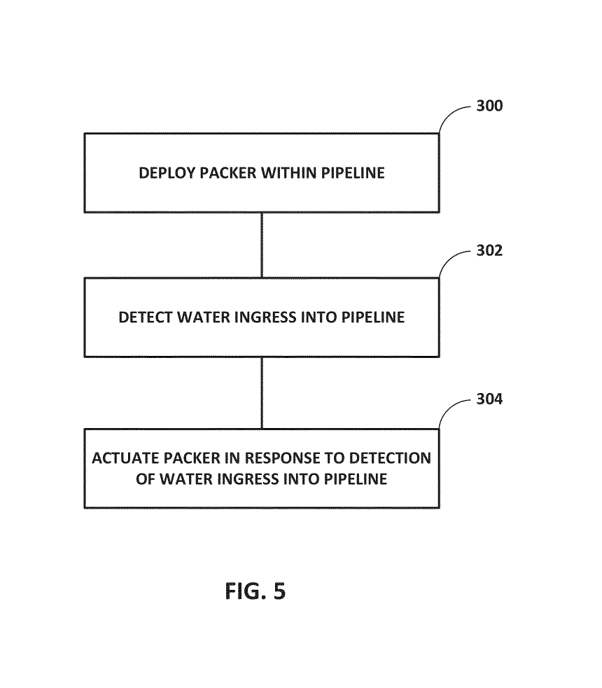

FIG. 5 is a flowchart depicting an example method of arresting a wet buckle of a submerged pipeline. The method includes deploying a packer apparatus within the pipeline (300), detecting water ingress into the pipeline (302), and actuating the packer apparatus in response to the detection of the water ingress into the pipeline (304). In one example, the packer includes first, second, and third mandrels, a brake, and first and second elastomeric expansion boots. The first and second mandrels are in axial moveable relation with the third mandrel, which is arranged between the first and second mandrels. The brake is arranged between the first and second mandrels. The first elastomeric expansion boot is arranged between a radially extending flange of the first mandrel and a first radially extending flange of the third mandrel. The second elastomeric expansion boot is arranged between a radially extending flange of the second mandrel and a second radially extending flange of the third mandrel.

The packer apparatus can be deployed into the pipeline via a hoist line connected to a hoist machine on a pipelay vessel. Detection of water ingress into the pipeline can include sensing water invasion into the inner diameter of the pipeline with a sensor included in or separate from the packer apparatus. In one example, the packer can include a sensor system that detects the invasion of water into the inner diameter of the pipeline. The sensor system communicatively coupled to the packer can provide a signal directly to control electronics included in an actuator of the packer or can transmit signals to a surface system, which, in turn, transmits control signals to the actuator via a supply line. In the event water invasion is detected, the actuator of the packer can trigger actuation of the device.

Actuating the packer apparatus can include transmitting signals from the pipelay vessel on the surface to the packer via the supply line connected to the actuator of the packer. The actuator can be configured to move the first mandrel axially toward the third mandrel from a first position to a second position. The actuator can also be configured to move the second mandrel axially toward the third mandrel from a first position to a second position. In one example, the actuator is configured is configured to cause the first and second mandrels to move toward the third mandrel substantially simultaneously.

In the second position of the first mandrel, the radially extending flange of the first mandrel is closer to the first radial extending flange of the third mandrel than in the first position, and the first expansion boot is compressed axially between the radially extending flange of the first mandrel and the first radially extending flange of the third mandrel and is expanded radially into engagement with an inner surface of the pipeline. In the second position of the second mandrel, the radially extending flange of the second mandrel is closer to the second radial extending flange of the third mandrel than in the first position, and the second expansion boot is compressed axially between the radially extending flange of the second mandrel and the second radially extending flange of the third mandrel and is expanded radially into engagement with an inner surface of the pipeline. Additionally, in the second position of the first and second mandrels, the brake moves radially outward into engagement with the inner surface of the pipeline.

As described above, methods of arresting failures of a submerged pipeline can include deploying multiple packers within the submerged pipeline. In one example, the packers are deployed on either side (e.g. one closer to the surface and one farther from the surface and closer to the sea floor) of the location of the wet buckle (or other failure). In such examples, both packers can be actuated to seal the region of the pipeline between the packers and including the location of the failure.

Various examples have been described. These and other examples are within the scope of the following claims.

I claim:

1. A packer apparatus configured to be arranged within and arrest a failure of a submerged pipeline, the packer apparatus comprising:
first and second mandrels in axial moveable relation with a third mandrel arranged between the first and second mandrels;
a brake arranged between the first and second mandrels;
a first elastomeric expansion boot arranged between a radially extending flange of the first mandrel and a first radially extending flange of the third mandrel; and
a second elastomeric expansion boot arranged between a radially extending flange of the second mandrel and a second radially extending flange of the third mandrel,
wherein the first mandrel is configured to move axially toward the third mandrel from a first position to a second position,
wherein, in the second position of the first mandrel:
the radially extending flange of the first mandrel is closer to the first radial extending flange of the third mandrel than in the first position, and the first expansion boot is compressed axially between the radially extending flange of the first mandrel and the first radially extending flange of the third mandrel and is expanded radially into engagement with an inner surface of the pipeline,
wherein the second mandrel is configured to move axially toward the third mandrel from a first position to a second position, and
wherein, in the second position of the second mandrel:
the radially extending flange of the second mandrel is closer to the second radial extending flange of the third mandrel than in the first position, and the second expansion boot is compressed axially between the radially extending flange of the second mandrel and the second radially extending flange of the third mandrel and is expanded radially into engagement with an inner surface of the pipeline, and
wherein, in the second position of the first and second mandrels:
the brake moves radially outward into engagement with the inner surface of the pipeline.

2. The apparatus of claim 1, wherein:
the first mandrel comprises a “T” shape comprising the radially extending flange and a central shaft,
the second mandrel comprises a “T” shape comprising the radially extending flange and a central shaft,
the third mandrel comprises an “I” shape comprising the first and second radially extending flanges and a shaft comprising a bore, and
the shaft of the first mandrel is received in a first end of the bore and the shaft of the second mandrel is received in a second end of the bore.

3. The apparatus of claim 2, wherein:
the shaft of the third mandrel comprises an axial slot, and
the brake is pivotally connected to the shaft of the first mandrel and the shaft of the second mandrel through the slot.

4. The apparatus of claim 3, wherein:
the shaft of the third mandrel comprises a plurality of axial slots disposed at different angularly disposed, circumferential positions about a longitudinal axis of the packer apparatus, and
the brake comprises a plurality of brake mechanisms disposed at different angularly disposed, circumferential positions about the longitudinal axis of the packer apparatus in alignment with the angular positions of the slots,
each of the brake mechanisms is pivotally connected to the shaft of the first mandrel and the shaft of the second mandrel through one of the slots.

5. The apparatus of claim 4, wherein each brake mechanism comprises:
a linkage; and
at least one pad,
wherein the linkage is pivotally connected to the shaft of the first mandrel and the shaft of the second mandrel and pivotally connected to the pad between the first and second mandrels.

6. The apparatus of claim 5, wherein each linkage comprises:
a first link comprising first and second ends;
a second link comprising first and second ends,
wherein:
the first end of the first link is pivotally connected to the shaft of the first mandrel,
the first end of the second link is pivotally connected to the shaft of the second mandrel,
the second end of the second link is pivotally connected to the pad, and
the second end of the first link is pivotally connected to the first link between the first end of the first link and the pad.

7. The apparatus of claim 5, wherein, for each brake mechanism, the at least one pad comprises a plurality of pads.

8. The apparatus of claim 5, wherein, for each brake mechanism, the at least one pad comprises a curved outer surface that substantially matches a curved inner surface of the pipeline.

9. The apparatus of claim 2, further comprising an actuator configured to cause the first mandrel to move axially toward the third mandrel from the first position to the second position, and to cause the second mandrel to move axially toward the third mandrel from the first position to the second position.

10. The apparatus of claim 9, wherein the actuator is configured to cause the first and second mandrels to move toward the third mandrel substantially simultaneously.

11. The apparatus of claim 9, wherein the actuator is arranged in the bore of the shaft of the third mandrel and is connected to the shaft of the first mandrel and the shaft of the second mandrel.

12. The apparatus of claim 9, wherein the actuator comprises at least one of a pneumatic, hydraulic, electrical, electromechanical, and electromagnetic actuator.

13. The apparatus of claim 1, further comprising at least one bearing comprising a plurality of wheels rotatably connected to the bearing and disposed at different angularly disposed, circumferential positions around a longitudinal axis of packer apparatus.

14. The apparatus of claim 1, further comprising a sensor configured to detect ingress of water into the pipeline.

15. The apparatus of claim 1, further comprising:
a first end cap defining a first end of the packer apparatus and comprising a conical or frustoconical shape; and
a second end cap defining a second end of the packer apparatus and comprising a conical or frustoconical shape.

16. A system for arresting a failure of a submerged pipeline,
the system comprising:
a hoist machine;
a packer apparatus configured to be arranged within the submerged pipeline, wherein the packer apparatus comprises:
first and second mandrels in axial moveable relation with a third mandrel arranged between the first and second mandrels;
a brake arranged between the first and second mandrels;
a first elastomeric expansion boot arranged between a radially extending flange of the first mandrel and a first radially extending flange of the third mandrel; and
a second elastomeric expansion boot arranged between a radially extending flange of the second mandrel and a second radially extending flange of the third mandrel,
wherein the first mandrel is configured to move axially toward the third mandrel from a first position to a second position,
wherein, in the second position of the first mandrel:
the radially extending flange of the first mandrel is closer to the first radial extending flange of the third mandrel than in the first position, and the first expansion boot is compressed axially between the radially extending flange of the first mandrel and the first radially extending flange of the third mandrel and is expanded radially into engagement with an inner surface of the pipeline,
wherein the second mandrel is configured to move axially toward the third mandrel from a first position to a second position, and
wherein, in the second position of the second mandrel:
the radially extending flange of the second mandrel is closer to the second radial extending flange of the third mandrel than in the first position, and the second expansion boot is compressed axially between the radially extending flange of the second mandrel and the second radially extending flange of the third mandrel and is expanded radially into engagement with an inner surface of the pipeline, and
wherein, in the second position of the first and second mandrels:
the brake moves radially outward into engagement with the inner surface of the pipeline; and
a hoist line comprising a first end operatively connected to the hoist machine and second end connected to the packer apparatus.

17. The system of claim 16, wherein:
the first mandrel comprises a “T” shape comprising the radially extending flange and a central shaft,
the second mandrel comprises a “T” shape comprising the radially extending flange and a central shaft,
the third mandrel comprises an “I” shape comprising the first and second radially extending flanges and a shaft comprising a bore, and
the shaft of the first mandrel is received in a first end of the bore and the shaft of the second mandrel is received in a second end of the bore.

18. The system of claim 17, wherein:
the shaft of the third mandrel comprises a plurality of axial slots disposed at different angularly disposed, circumferential positions about a longitudinal axis of the packer apparatus, and
the brake comprises a plurality of brake mechanisms, wherein each of the brake mechanisms is pivotally connected to the shaft of the first mandrel and the shaft of the second mandrel through one of the slots.

19. The system of claim 18, wherein each brake mechanism comprises:
a linkage; and
at least one pad,
wherein the linkage is pivotally connected to the shaft of the first mandrel and the shaft of the second mandrel and pivotally connected to the pad between the first and second mandrels.

20. The system of claim 18, wherein each linkage comprises:
a first link comprising first and second ends;
a second link comprising first and second ends,
wherein:
the first end of the first link is pivotally connected to the shaft of the first mandrel,
the first end of the second link is pivotally connected to the shaft of the second mandrel,
the second end of the second link is pivotally connected to the pad, and
the second end of the first link is pivotally connected to the first link between the first end of the first link and the pad.

21. The system of claim 18, wherein, for each brake mechanism, the at least one pad comprises a plurality of pads.

22. The system of claim 18, wherein, for each brake mechanism, the at least one pad comprises a curved outer surface that substantially matches a curved inner surface of the pipeline.

23. The system of claim 17, further comprising an actuator configured to cause the first mandrel to move axially toward the third mandrel from the first position to the second position, and to cause the second mandrel to move axially toward the third mandrel from the first position to the second position.

24. The system of claim 16, further comprising at least one bearing comprising a plurality of wheels rotatably connected to the bearing and disposed at different angularly disposed, circumferential positions around a longitudinal axis of packer apparatus.

25. The system of claim 16, further comprising a sensor configured to detect ingress of water into the pipeline.

26. The system of claim 16, further comprising:
a first end cap defining a first end of the packer apparatus and comprising a conical or frustoconical shape; and
a second end cap defining a second end of the packer apparatus and comprising a conical or frustoconical shape.

27. A system for arresting a failure of a submerged pipeline,
the system comprising:
a first packer apparatus configured to be disposed at a first position within the pipeline; and
a second packer apparatus configured to be disposed at a second position within the pipeline,
wherein at least one of the first and the second packer apparatus comprises:
first and second mandrels in axial moveable relation with a third mandrel arranged between the first and second mandrels;
a brake arranged between the first and second mandrels;
a first elastomeric expansion boot arranged between a radially extending flange of the first mandrel and a first radially extending flange of the third mandrel; and
a second elastomeric expansion boot arranged between a radially extending flange of the second mandrel and a second radially extending flange of the third mandrel,
wherein the first mandrel is configured to move axially toward the third mandrel from a first position to a second position,
wherein, in the second position of the first mandrel:
the radially extending flange of the first mandrel is closer to the first radial extending flange of the third mandrel than in the first position, and the first expansion boot is compressed axially between the radially extending flange of the first mandrel and the first radially extending flange of the third mandrel and is expanded radially into engagement with an inner surface of the pipeline,
wherein the second mandrel is configured to move axially toward the third mandrel from a first position to a second position, and
wherein, in the second position of the second mandrel:
the radially extending flange of the second mandrel is closer to the second radial extending flange of the third mandrel than in the first position, and the second expansion boot is compressed axially between the radially extending flange of the second mandrel and the second radially extending flange of the third mandrel and is expanded radially into engagement with an inner surface of the pipeline, and
wherein, in the second position of the first and second mandrels:
the brake moves radially outward into engagement with the inner surface of the pipeline.

28. A method of arresting a failure of a submerged pipeline,
the method comprising:
deploying a packer apparatus within the pipeline, wherein the packer apparatus comprises:
first and second mandrels in axial moveable relation with a third mandrel arranged between the first and second mandrels;
a brake arranged between the first and second mandrels;
a first elastomeric expansion boot arranged between a radially extending flange of the first mandrel and a first radially extending flange of the third mandrel; and
a second elastomeric expansion boot arranged between a radially extending flange of the second mandrel and a second radially extending flange of the third mandrel,
detecting ingress of water into the pipeline;
actuating the packer apparatus, wherein actuating the packer apparatus comprises:
moving the first mandrel axially toward the third mandrel from a first position to a second position, wherein, in the second position of the first mandrel:
the radially extending flange of the first mandrel is closer to the first radial extending flange of the third mandrel than in the first position, and the first expansion boot is compressed axially between the radially extending flange of the first mandrel and the first radially extending flange of the third mandrel and is expanded radially into engagement with an inner surface of the pipeline,
moving the second mandrel axially toward the third mandrel from a first position to a second position, wherein, in the second position of the second mandrel:
the radially extending flange of the second mandrel is closer to the second radial extending flange of the third mandrel than in the first position, and the second expansion boot is compressed axially between the radially extending flange of the second mandrel and the second radially extending flange of the third mandrel and is expanded radially into engagement with an inner surface of the pipeline, and
wherein, in the second position of the first and second mandrels:
the brake moves radially outward into engagement with the inner surface of the pipeline.
